(19) United States
(12) Patent Application Publication
(10) Pub. No.: US 2018/0042710 A1
(43) Pub. Date: Feb. 15, 2018

(54) PROSTHESIS BASE AND METHOD FOR INTEGRALLY BONDING AT LEAST ONE ARTIFICIAL TOOTH TO A PROSTHESIS BASE

(71) Applicant: HERAEUS KULZER GMBH, Hanau (DE)

(72) Inventors: Novica SAVIC, Erlensee (DE); Karl-Heinz RENZ, Alzenau (DE); Silke Maren Gall, Aschaffenburg (DE)

(73) Assignee: KULZER GMBH, Hanau (DE)

(21) Appl. No.: 15/320,053

(22) PCT Filed: Jun. 17, 2015
(86) PCT No.: PCT/EP2015/063571

§ 371 Date: Dec. 19, 2016

(30) Foreign Application Priority Data
Jun. 18, 2014 (DE) 10 2014 108 632.5

(51) Int. Cl. A61C 13/10; A61C 13/01; A61C 13/00

(52) U.S. Cl. CPC A61C 13/102; A61C 13/0004; A61C 13/01

(57) ABSTRACT

The invention relates to a prosthesis base, which is made entirely or partially of a prosthesis material and/or wax and has on its top face at least one substantially custom-fit recess (3) for zonally receiving an artificial tooth (1). According to the invention at least one channel (5) is formed in the prosthesis base (2), which opens into said recess (3).

Furthermore, the invention relates to a process for the substance-to-substance bond of an artificial tooth (1) to a prosthesis base (2), which is made entirely or partially of a prosthesis material and/or wax and has at least one substantially custom-fit recess (3) for zonally receiving said artificial tooth (1).

The invention relates to a prosthesis base, which is made entirely or partially of a prosthesis material and/or wax and has on its top face at least one substantially custom-fit recess for zonally receiving an artificial tooth. Furthermore, the invention relates to a process for the substance-to-substance bond of an artificial tooth to such a prosthesis base.

The proposed prosthesis base is particularly suitable for carrying out the proposed process.

The proposed process preferably is used in a process for producing a partial or total prosthesis. It can be used to form the final connection of at least one artificial tooth to a prosthesis base made of a prosthesis material or the temporary connection of at least one artificial tooth to a wax base in order to create, for example, a wax model of the later prosthesis or to make a tooth set-up in wax.

Producing a tooth set-up in wax represents an intermediate step in a process for producing a partial or total prosthesis. It is used for precise positioning of the teeth in order to obtain the mastication function later on, which is clinically necessary. To finish the prosthesis, the wax is then replaced by a prosthesis material. This can be done in such a way that the set-up in wax is embedded in a curable casting material, such as plaster, and the prosthesis base made of wax as a wax model (in the form of the prosthesis base made of prosthesis material) is removed after curing of the casting material by extraction with hot water. Subsequently, the remaining cavity is filled with the actual prosthesis material for producing the prosthesis base. After curing of the prosthetic material the required connection of the artificial teeth to the prosthetic material has been established. A tooth set-up in wax is used particularly in the traditional production of prostheses. The wax base is then fabricated on the basis of an impression of the oral situation of the patient.

In addition, processes for producing prostheses are known in which the tooth set-up is carried out only virtually. Such processes are described by way of example in DE 103 04 757 B4 and DE 10 2009 037 916 A1. First, the oral situation of the patient is scanned and a virtual model is created. In this model, the artificial teeth which also were scanned previously or which are available already as a data set, are fitted—virtually—. Based on the digital data of the virtual tooth set-up a functional model of a prosthesis base can be produced by rapid manufacturing or rapid prototyping, whereby said functional model already has custom-fit recesses for receiving the artificial teeth. The functional model is utilised for producing a negative mould into which the prosthesis material is filled for producing the final prosthesis base. According to the functional model the prosthesis base also possesses custom-fit recesses for receiving the artificial teeth, so that they only need to be plugged in and connected to the prosthesis base.

The connection of the artificial teeth to the prosthesis base is generally established using an adhesive. This requires, however, that there is enough space present for accommodating the adhesive in the recesses of the prosthesis base. If this is not the case, the artificial teeth have to be shortened or sharpened from below, i.e. basally. This can cause the teeth to no longer fit into the respective recesses of the prosthesis base and the artificial teeth and/or the prosthesis base must be further reworked.

To prevent this, initially, a prosthesis base made of wax can be produced, based on the digital data of a virtual tooth set-up. Then, the prefabricated artificial teeth are inserted into the wax base. In this manner, the virtual tooth set-up is converted into a real tooth set-up. To finalise the prosthesis the wax must then only be replaced with the actual prosthetic material. The procedure in this case is the same as described previously in connection with the traditional process.

If initially a wax model of the actual prosthesis base is created, the artificial teeth must be connected to the wax base as well. Ideally, this is done by partially melting the wax and inserting the teeth into the partially melted wax. After re-solidification of the wax, a fixed connection is then made. However, commercially available set-up or base plate wax has the disadvantage that upon partially melting it quickly passes into a liquid state. If the wax is not only melted partially, but completely, i.e. liquefied, form changes may occur which lead to a deviation of the real model from the virtual model. Accuracy of fit of the recesses provided for receiving the artificial teeth is then no longer guaranteed.

Connecting an artificial tooth to a prosthesis base in a process for producing a partial or total prosthesis is a step that is difficult to implement, regardless of whether the tooth is to be connected to a prosthesis base made of a prosthesis material for producing the finished prosthesis or with a wax base for producing a preliminary wax model.

The present invention is therefore based on the object to facilitate connecting an artificial tooth to a prosthesis base.

To achieve the object, the prosthesis base with the features of claim 1 and the process with the features of claim 8 are proposed. Advantageous embodiments of the invention are disclosed in the respective dependent claims.

The proposed prosthesis base is made, particularly entirely or partially, of a prosthesis material and/or wax and has on its top face at least one substantially custom-fit recess for zonally receiving an artificial tooth. According to the invention at least one channel is formed in the prosthesis base, which opens into said recess. The channel is used for receiving a dissolving, curing or hardening material for connecting an artificial tooth to the prosthesis base.

According to the present invention, the prosthesis base is meant to be the prosthesis base made of prosthesis material, the wax model of the actual prosthesis base made of prosthesis material or a functional model made of a different material. The prosthesis base forms the bottom face of a removable prosthesis. The prosthesis base can also be part of a partial prosthesis, total or full prosthesis, fixed prosthesis or at least a prosthetic saddle in a partial prosthesis.

Since usually it is necessary to connect more than just one artificial tooth to the prosthesis base in producing partial or total prostheses, said prosthesis preferably has several recesses, wherein the number of recesses further preferably corresponds to the number of teeth. Advantageously, a channel opens into each recess to cause a substance-to-substance bond of an artificial tooth inserted into the recess to the prosthesis base by introducing a curing or hardening material into the channel. Accordingly, the prosthesis base preferably has a plurality of such channels which extend along the dental arch. The distance between the channels are, in particular, determined by the respective distances between teeth.

Preferably, the channel opening into the recess runs from the recess to the bottom face of the prosthesis base. Hence, even with a tooth inserted into the recess, the channel therefore remains easily accessible to introduce the curing or hardening material. Further preferably, the channel runs straight to facilitate the introduction of the curing or hardening material further. In addition, a straight running channel may be kept short, so that as little material as possible is consumed when completely filling the channel with the curing or hardening material. At the same time, a short channel promotes a rapid and uniform curing or hardening of the material. Likewise, the channels may be of any geometry, hence the channels can also run preferably vertically, however, optionally at least one channel may be formed slanted, angled or bent as well. The channels may have cylindrical geometries or polyhedral geometry and any irregular geometry.

The prosthesis base according to the invention has on its top face at least one substantially custom-fit recess for zonally receiving an artificial tooth, the prosthesis base preferably having up to 16 recesses, where at least one channel per recess is formed in the prosthesis base, which opens into the respective recess, wherein (a) said channel runs, preferably straight, angled or bent, from said recess to the bottom face (basal) of said prosthesis base, b) said channel runs, preferably straight, angled or bent from the recess to a vestibular side of said prosthesis base, or c) said channel runs, preferably straight, angled or bent from said recess to a lingual side of said prosthesis base. Thus, a channel according to the invention may have an opening of the channel at the bottom face, at the vestibular side or at the lingual side of the prosthesis base. According to the invention a continuous channel, each with its own opening of the channel at the aforementioned sides a), b) or c) may be assigned independently to each recess. Alternatively, also preferred is a bundling of at least two channels of the aforementioned recesses which open into a common opening at the aforementioned sides a), b) or c). Thus, it is possible that two adjacent artificial teeth are inserted into the appropriate recess and the substance-to-substance bond can be established by means of a curing and hardening material that has been introduced into a common, preferably vestibularly disposed opening. To avoid possible irritation of the mucosa as well as to ensure a perfect fit and thus good adhesion of the prosthesis base, the surface of the prosthesis base can subsequently be post-treated, in particular polished, at the opening of the original channels. Thus, according to an alternative, the outer surfaces of the prosthesis base adjacent to the gingiva of the lower jaw and to the gingiva of the upper jaw and which are responsible for good adhesion of the prosthesis base can be produced without openings of the channels by the process according to the invention. The side of the prosthesis base facing the mucosa (gingiva) is an area which so far has not been provided with openings by dental technicians due to the necessary very custom-fit geometry for adaptation to the mucosa. Preferably, all openings sealed with hardened material are post-treated, in particular polished, to ensure optimally the adaptation of the prosthesis base to the mucosa. Thus, this ensures also a homogenous surface of the prosthesis causing little irritation also at the bottom face, vestibularly or lingually.

Advantageously, the channel opens substantially centrally with respect to the recess into the recess. This ensures a sufficient distance of the channel to the peripheral regions of the recess so that a breaking through of the curing or hardening material at a peripheral region of the recess is prevented. When using liquid wax as a curing or hardening material it also ensures that the peripheral regions of the recess are not partially melted, but remain firm in order to obtain the accuracy of fit of the recess.

Alternatively or additionally, it is proposed that the channel has a widening at least in the area of where it opens into the recess. The widening creates an additional volume which can be filled with the curing or hardening material to increase the contact area of the material with the artificial tooth and, consequently, to improve adhesion. It is not necessary in this case, that material also enters the recess. This measure also contributes therefore to obtaining the accuracy of fit of the recess.

Particularly preferably, in addition to a substance-to-substance bond, the curing or hardening material can establish a form-fitting connection between the prosthesis base and the artificial tooth so that the tooth is also fixed mechanically in the prosthesis base. This is possible, for example, by the prosthesis base and/or the artificial tooth having undercuts in which the hardening or curing material can flow in the uncured state. The invention therefore also relates to a prosthesis, in particular an artificial tooth having at least one recess and/or undercut at its outer contour. Particularly preferred is an artificial tooth having at least one recess or undercut at the outer contour in the crestal to the apical area of the artificial tooth. Therefore, preferably, the at least one recess and/or undercut is provided at the outer contour cervically, and/or radicularly and/or apically. The undercuts are preferably elongated, corrugated, have a profile or have any geometry, wherein the at least one undercut is inclined by at least 1°, preferably 5°, from the tooth centre line. The purpose of the undercut is a better anchoring when bonding with the prosthesis base. Thus, the prosthesis base in the at least one recess can have at least one undercut, to allow for an additional mechanical anchoring with the teeth after curing of the material. The recess or the undercut can be formed having a profile, as a lumen or as a random or regular pattern of recesses and/or undercuts. The recess and/or undercuts are located in the basal area of the prosthesis, which is arranged in the prosthesis base and will not be visible afterwards.

In the case of a dental prosthesis, a prosthetic saddle is the part of the prosthesis, which abuts the jawbone. In the prosthesis base the channels according to the invention preferably have a defined arrangement, in which the at least one channel is formed in the area of the prosthetic saddle of the prosthesis base, and, in particular, simulates at least a portion of a dental arch. Preferably, 1, 2, 3, 4, 5, 6, 8, 9, 10, 16, 20, 28 up to 50, in particular 1 to 10, up to 14 or 16 channels are arranged in the prosthetics saddle of the prosthesis base.

The accuracy of fit of the recess is preferably embodied in the fact that the recess has an inner contour which is, at least zonally adapted to the outer contour of the artificial tooth. Since the artificial tooth is usually connected to the prosthesis base via its basal area, the inner contour of the recess preferably corresponds to the outer contour of the basal area of the artificial tooth. Particularly preferably, the recess is adapted to the outer contour of the artificial tooth in a manner, facilitating a form-fitting, force-fitting or cohesive joining of the prosthesis base and the artificial teeth.

Particularly preferably, the prosthesis base has been produced by means of a CAD/CAM process. Fabrication by means of a CAD/CAM process allows in a simple manner the formation of a custom-fit recess in the prosthesis base, into which then the artificial tooth is inserted later. Further preferably, fabrication of the prosthesis base by means of a CAD/CAM process is preceded by a virtual tooth set-up. Here, at least one prefabricated artificial tooth which is present as a data set, is fitted into a virtual model, so that a particularly high accuracy of fit of the recess provided in the prosthesis base for receiving the tooth can be achieved. Because the inner contour of the recess of the prosthesis base in this case corresponds precisely to the outer contour of the artificial tooth in the respective connecting region.

The virtual tooth set-up also offers the possibility to specify the location and size of the channel so that the channel can be fabricated together with the prosthesis base. Regardless of whether the fabrication of the prosthesis base was preceded by a virtual tooth set-up, it is also possible, however, to introduce the channel later on. To this end, the prosthesis base which is preferably produced by means of a CAD/CAM process can be perforated with channels in a subsequent step.

Ideally, the custom-fit recess of the prosthesis base has a maximum dimensional deviation of 100 μm, preferably 50 μm, more preferably 30 μm with respect to a corresponding recess of a casting model or a virtual model.

The prosthesis base according to the invention can be formed with a palatal plate, preferably for an upper jaw prosthesis, or formed such that the sublingual area is extended as preferably in case of a lower jaw prosthesis.

Suitable prosthesis material is, in particular, a plastic, such as polymerisable dental plastics. Preferably, conventional polymerisable prosthetic materials, such as those described in EP 1702633 B1, DE 19617876, EP 2529762, are used to manufacture the prosthesis base. The prosthesis base is then based on the polymerised prosthesis base materials as prosthesis material. A possible prosthesis base material comprises a polymerisable, in particular autopolymerising or cold polymerising or hot polymerisable or radiation-curable composition containing (A) a liquid monomer component, (B) a powdered component comprising, in particular, PMMA, (C) at least one initiator or initiator system for the polymerisation. Furthermore, the components (A) and/or (B) may comprise at least one member of the groups of the aliphatic urethane acrylates and/or aliphatic urethane methacrylates.

In the process, which is further proposed to achieve the aforementioned object, of cohesively connecting an artificial tooth to a prosthesis base, a prosthesis base is used, which is made especially entirely or partially of a prosthesis material and/or wax. Further, the prosthesis base has on its top face at least a substantially custom-fit recess for zonally receiving an artificial tooth. According to the invention the substance-to-substance bond is established by means of a curing or hardening material, which is introduced into a channel formed in the prosthesis base and which opens into the recess, so that the material contacts the artificial tooth inserted or still to be inserted into the recess.

Thus, subject of the invention is also a prosthesis obtainable according to the process of the invention.

The channel can be filled completely or only partially with the dissolving, curing or hardening material. In the latter case, it must be ensured that at least the area of the mouth of the channel is filled with the material, so that the contact required for substance-to-substance bond to the tooth is or can be established. The substance-to-substance bond is then effected by curing or hardening of the material.

When introducing the dissolving, curing or hardening material into the channel, no or very little material enters the recess so that the accuracy of fit of the recess is retained and a reworking of the tooth and/or of the prosthesis base is no longer necessary. In this way, the connection of the artificial tooth to the prosthesis base can be effected quickly and easily.

Whether the curing or hardening material enters the recess when being introduced into the channel, depends, inter alia, on the viscosity of the material. Preferably, a curing or hardening material having very low viscosity is used for the substance-to-substance bond. Because then the material can enter into a gap between an already inserted artificial tooth and the prosthesis base, so that the contact area of the material with the tooth is increased. The increased contact area improves the adhesion, providing a secure connection of the artificial tooth to the prosthesis base. In addition, the accuracy of fit of the recess is retained.

Alternatively or additionally, an enlargement of the contact area may be achieved in that the channel has a widening in the area where it opens. In this case the recess may remain completely free from the curing or hardening material, so that the accuracy of fit of the recess remains unchanged.

According to a preferred alternative, the prosthesis base is produced in a CAD/CAM process and provided with the at least one channel.

Preferably, the curing or hardening material is introduced into the channel after insertion of the artificial tooth into the recess of the prosthesis base. The tooth already inserted prevents more curing or hardening material to pass than desired from entering the recess. Because no more material can enter the space occupied by the tooth. Consequently, the accuracy of fit is retained. Advantageously, a curing or hardening material having a very low viscosity is used, as it can enter into and fill any remaining gap between the artificial tooth and the prosthesis base. Accordingly, no cavities remain between the tooth and the prosthesis base which is desirable in view of keeping the prosthesis clean. At the same time, curing or hardening material that enters into a gap between the tooth and the prosthesis base increases the area of surface adhesion.

Alternatively, the curing or hardening material can be introduced into the channel even before inserting the tooth in the recess of the prosthesis base. In case more material than desired enters the recess through the channel, excess material can be pushed back into the channel when inserting the tooth into the recess. This approach ensures optimum wetting of the artificial tooth with the curing or hardening material and thus, good adhesion. In this case also, the use of a curing or hardening material having a very low viscosity is preferred such as polymerisable monomers, solvents or mixtures thereof.

Ideally, the curing or hardening material is always introduced from the bottom face of the prosthesis base, wherein the bottom face is the side of the prosthesis base which is facing away from the top face with the recess. In this way the channel remains accessible even when the artificial tooth has already been inserted into the recess.

According to a preferred embodiment of the invention, the curing or hardening material is introduced into the channel by means of an injection device. Such injection device enables a precisely metered introduction of the material. Further, the material can be placed precisely by the injection device, for example by inserting an application needle of the injection device into the channel. In this way the introduction of the curing or hardening material can be limited to a localised area of the channel, so that it is not necessary to fill the entire channel with the material.

Alternatively, the curing or hardening material can be pressed into the channel. For this purpose, for example, the prosthesis base can be pressed into a bed with the curing or hardening material, so that the channel is completely filled with the curing or hardening material.

Preferably, the curing or hardening material is an adhesive. This is especially true when it is necessary to connect the artificial tooth to a prosthesis base made of a prosthesis material. From the dental art, numerous adhesives are already known, which are usable in the proposed process. Especially suitable are adhesives based on specific monomers such as polymerisable monomers, in particular based on acrylates or liquefied wax which is used as a hardening or hardening material (4).

Preferably, liquefied wax is utilised as curing or hardening material when connecting an artificial tooth to a wax base. The wax is heated to liquefaction and introduced into the channel of the wax base. Thereby, the heated wax leads to a partially melting of the wax of the wax base in the area of the channel, i.e. also where the mouth of the channel enters into the recess. This contributes to an increase of the area of surface adhesion and, consequently, an improved adhesion is achieved. The area which is partially melted by the wax that has been heated to liquefaction should, however, be limited to an area around the centre of the recess to ensure the accuracy of fit of the recess. This means that, preferably, the peripheral regions of the recess, which serve as the socket of the artificial tooth, are not partially melted or softened to retain their custom-fit shape. To achieve this, at least the area of the mouth of the channel is arranged substantially centrally in relation to the recess.

A central arrangement is also beneficial when using an adhesive for the substance-to-substance bond of the artificial tooth to the prosthesis base. Because of the central arrangement, preferably at the base of the recess, prevents any excess adhesive from passing over the peripheral regions of the recess. This is especially true when the adhesive is introduced first, and then, the tooth is inserted into the recess.

Preferred embodiments of the prosthesis base according to the invention are described below with reference to the accompanying drawings. Furthermore, the process according to the invention is explained with reference to the drawings using a prosthesis base according to the invention. In the drawings:

FIG. 1 shows a schematic cross section of a prosthesis base according to the invention,

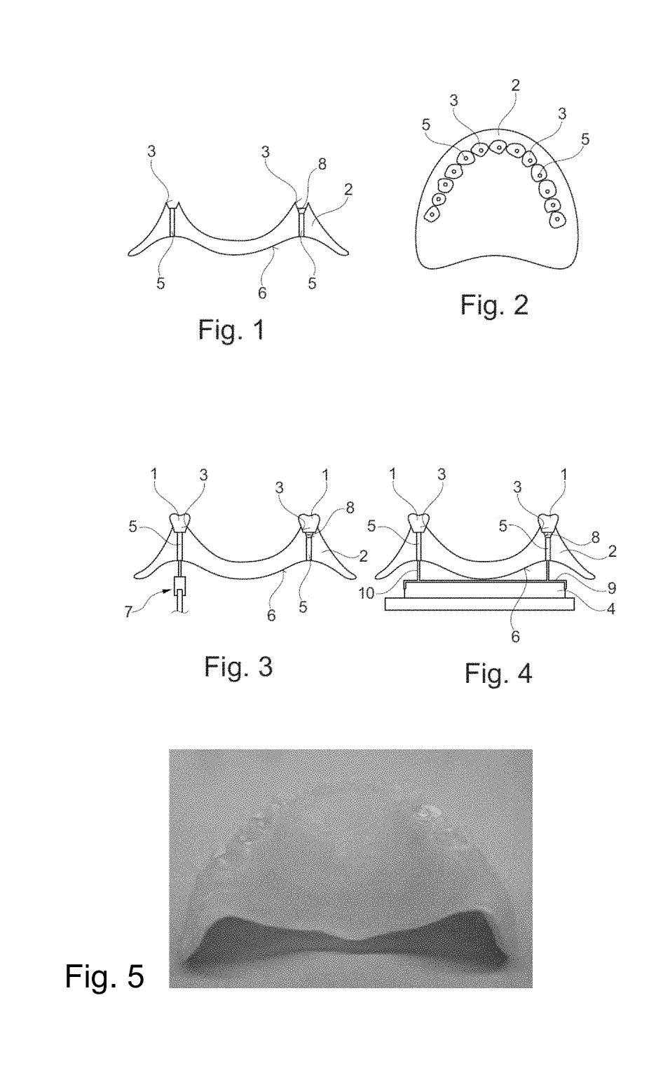

FIG. 2 shows a schematic plan view of the prosthesis base of FIG. 1,

FIG. 3 shows the cross section of FIG. 1 with artificial teeth inserted into the prosthesis base during the substance-to-substance bond by means of an injection device, and

FIG. 4 shows the cross section of FIG. 1 with artificial teeth inserted into the prosthesis base during substance-to-substance bond by means of pressing into a material bed.

FIG. 5 depicts a prosthesis base in accordance with the prior art that preferably can be provided with recesses 3 and channels according to the invention.

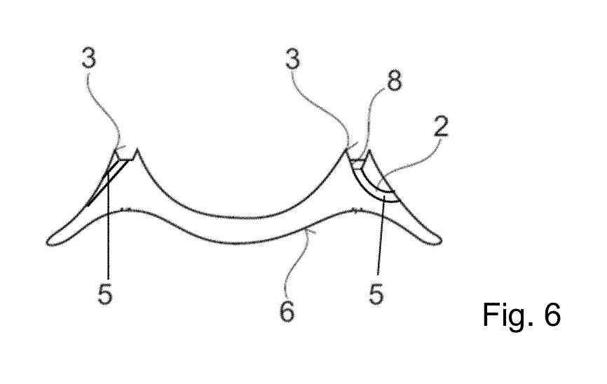

FIG. 6 depicts a prosthesis base having two exemplary channels 5, which run to the vestibular side of the prosthesis base where they have their respective channel opening.

### DETAILED DESCRIPTION OF THE DRAWINGS

The prosthesis base 2 which is made of plastic and is schematically illustrated in cross section in FIG. 1 was prepared on the basis of a virtual tooth set-up by means of a CAD/CAM process. It has a curved bottom face 6, which is adapted to the actual situation of the upper jaw of the patient. The top face has recesses 3, each serving to receive an artificial tooth 1 (see FIGS. 3 and 4). The inner contour of recesses 3 is adapted to the outer contour of each artificial tooth 1 to be received. Accordingly, recesses 3 represent custom-fit seats for the artificial teeth 1 to be inserted. A channel 5 that serves reception of a curing or hardening material 4 for the substance-to-substance bond of the artificial tooth 1 to the prosthesis base 2 opens in each case into recesses 3 substantially centrally. The material 4 may be, in particular, an adhesive. Channels 5 each run straight such as vertical, slanted, angled or bent, preferably straight, from the base of the respective recess 3 to bottom face 6 of the prosthesis base 2, so that it is possible to introduce the curing or hardening material 4 from the bottom face into the respective channel 5. Correspondingly, FIG. 6 shows channels 5 running to the vestibular sides of the prosthesis base. According to a particularly preferred alternative the at least one channel 5 runs preferably straight, angled or bent from recess 3 to a vestibular side of prosthesis base 2, as shown in FIG. 6. Thus, according to this alternative, the at least one channel 5 ends in the prosthesis base preferably in the area of the cheek or lip. After introducing the hardening material 4 and curing of the material the original vestibular opening of the channel can be post-treated, particularly polished, in order to ensure a homogeneous surface of the prosthesis base with little irritation at this position. A similar procedure is applied to filled openings originally present at the bottom face.

As exemplified on the right side of the drawing of FIG. 1 the channel 5 may have a widening 8 in the area where it opens into recess 3. In the present case, the widening 8 is conically shaped and widens towards the recess 3. When introducing the curing or hardening material 4 into the channel 5, the area of widening 8 is completely filled with the material 4. Thus, the contact area of material 4 with the artificial tooth 1 inserted into recess 3 increases, so that an even better adhesion is achieved.

FIG. 2 illustrates a highly simplified top view of prosthesis base 2 of FIG. 1. The top view shows recesses 3 and channels 5 opening substantially centrally into recesses 3. As apparent from FIG. 2 recesses 3 including channels 5 are arranged along the dental arch.

An artificial tooth 1 can be connected to prosthesis base 2 as shown in FIG. 3. First, artificial tooth 1 is inserted into the custom-fit recess 3 of prosthesis base 2. Then, the curing or hardening material is introduced through the associated channel 5 by means of an injection device 7. For this purpose the injection device 7 is inserted into channel 5, in order to ensure that material 4 contacts artificial tooth 1. When introducing material 4 into channel 5, the injection device 7 is then withdrawn, so that channel 5 is filled completely with material 4.

Alternatively, an approach as shown in FIG. 4 can be used. Here, prosthesis base 2 with artificial teeth 1 inserted therein is pressed against a plate 9 with tubular applicators 10 dipping into channels 5. The curing or hardening material 4 is located below plate 9 and is pushed or pressed into channels 5 by the downward movement of prosthesis base 2 and plate 9 via applicators 10. Once channels 5 are completely filled with material 4, prosthesis base 2 is removed.

A further variant (not shown) for the substance-to-substance bond of artificial teeth 1 to the prosthesis base 2 is the direct pushing of prosthesis base 2 in a bed of the curing or hardening material 4. In this case no tool for introducing material 4 in a channel 5 is required. However, any material 4 still adhering to bottom face 6 of prosthesis base 2 may subsequently need to be removed.

### LIST OF REFERENCE NUMBERS

1 Artificial tooth
2 Prosthesis base
3 Recess
4 Curing or hardening material
5 Channel
6 Bottom face of prosthesis base
7 Injection device
8 Widening
9 Plate
10 Applicator

1. A prosthesis base which on its top face has at least one substantially custom-fit recess for zonally receiving an artificial tooth,
wherein in the prosthesis base at least one channel is formed, which opens into the recess.

2. The prosthesis base according to claim 1,
wherein a) said channel runs, optionally straight, angled or bent, from said recess to the bottom face of said prosthesis base, b) said channel runs, optionally straight, angled or bent, from said recess to a vestibular side of said prosthesis base, or c) said channel runs, optionally straight, angled or bent, from said recess to a lingual side of said prosthesis base.

3. The prosthesis base according to claim 1,
wherein said channel opens substantially centrally with respect to the recess into said recess and/or has a widening at least in the area where it opens into said recess.

4. The prosthesis base according to claim 1,
wherein said recess has an inner contour which is adapted at least partially to the outer contour of the artificial tooth.

5. The prosthesis base according to claim 1,
wherein said prosthesis base has been produced by means of a CAD/CAM process.

6. The prosthesis base according to claim 1,
wherein said custom-fit recess of said prosthesis base has a maximum dimensional deviation of 100 μm with respect to a corresponding recess of a casting model or a virtual model.

7. The prosthesis base according to claim 1,
which is made entirely or partially of a prosthesis material and/or wax.

8. The prosthesis base according to claim 1,
wherein the prosthesis material comprises a plastic or a polymerised prosthetic material, which can be obtained by polymerisation of a liquid monomer component and a powder component.

9. A process for the substance-to-substance bond of an artificial tooth to a prosthesis base having on its top face at least one substantially custom-fit recess for zonally receiving an artificial tooth,
said process comprising establishing the substance-to-substance bond by means of a curing or hardening material, which is introduced into a channel formed in the prosthesis base and which opens into said recess, so that said material contacts said artificial tooth inserted or still to be inserted into said recess.

10. The process according to claim 9,
wherein said curing or hardening material is introduced into said channel before or after inserting said artificial tooth into said recess of said prosthesis base, wherein introducing from the bottom face of said prosthesis base (2) is optional.

11. The process according to claim 9,
wherein said curing or hardening material is introduced by means of an injection device into said channel.

12. The process according to claim 10,
wherein said curing or hardening material is pressed into said channel.

13. The process according to claim 9,
wherein an adhesive, polymerisable monomers, or liquefied wax is used as curing or hardening material.

14. A prosthesis, wherein said prosthesis is at least one tooth, optionally an artificial tooth, said tooth having at least one undercut at its outer contour.

15. A prosthesis obtainable by a process according to claim 9.

16. A wax model, which is present in the form of a prosthesis base according to claim 1.
